(19) United States
(12) Patent Application Publication
(10) Pub. No.: US 2004/0128268 A1
(43) Pub. Date: Jul. 1, 2004

(54) Best American healthcare system

(76) Inventor: Anuthep Benja-Athon, New York, NY (US)

Correspondence Address: ANUTHEP BENJA-ATHON, M.D., 210 East 36th Street, New York, NY, 10016, US

(21) Appl. No.: 10/328,993

(22) Filed: Dec. 26, 2002

(51) Int. Cl. G06F 7/00

(52) U.S. Cl. 707/1

(57) ABSTRACT

The best healthcare system for optimizing healthcare providers' productivity, safeguarding healthcare consumers' health, reducing or eliminating healthcare providers' medical errors and maximizing healthcare buyers' return or yield comprising continuums and links of information on the accessibility of the healthcare providers, healthcare providers' medical findings, determinations, actions, plans and prescriptions relate to healthcare consumers, healthcare consumers' and buyers' healthcare-purchasing cooperative or cooperatives comprising pooled resource means for compensating for the goods and services provided by the healthcare providers and a means for utilizing a resource means for optimally benefiting healthcare consumers, buyers and providers as a function of optimal healthcare goods and services and proportionate and adjustable compensations based on the utilizations of healthcare goods and services by the healthcare consumers, the dispensations, efficiency and outcomes of services provided by, performances, merits and ranking of the healthcare providers.

### FIELD OF INVENTION

The best healthcare system.

### BACKGROUND OF THE INVENTION

U.S. Pat. No. 6,132,218 entitled Images for Communication of Medical Information in Computer was granted to this applicant on Oct. 17, 2000, and a pending patent, docket number ABA207, entitled the Best Healthcare System filed Nov. 18, 2002 now abandoned, represent this applicant's continual quest to solve the current healthcare crisis and improve the American standard of living.

As stated earlier in the Best Healthcare System, under the current American healthcare system, patients, employers, companies and the government face increasing healthcare and business costs, out-of-pocket expenses and premiums at alarming rates of about 15%-27% while healthcare is speedily deteriorating resulting in pain, suffering and untimely deaths. Prior to said patent pending, no one has the solution to, knowlege and means for solving the current healthcare crisis facing all Americans.

The first objective of the present invention is to provide the best healthcare system in the world.

The second objective is to solve the current American healthcare crisis.

The third objective is to provide the best method and means for providing and delivering the best healthcare at more affordable costs to Amricans and people in other nations.

The fourth objective is to provide the universal accessibility to the best, uniform and equitable healthcare for all Americans including the uninsured and underinsured and people in other countries.

The fifth objective is to lead to many major milestone achievements in healthcare and medicine.

### SUMMARY OF THE INVENTION

There is no solution to the current healthcare crisis affecting all Americans. The healthcare costs to people, companies and government are escalating while healthcare and standard of living are deteriorating and people's lives are being jeopardized.

The present invention is the best healthcare system for optimizing healthcare providers' productivity, safeguarding healthcare consumers' health, reducing or eliminating healthcare providers' medical errors, curbing escalating healthcare costs and maximizing healthcare buyers' return or yield. The present invention comprises continuums and links of information on the accessibility of healthcare providers', healthcare providers' medical histories and physical examinations, determinations, actions, plans and prescriptions relate to healthcare consumers, healthcare consumers' and buyers' healthcare-purchasing cooperative or cooperatives comprising pooled resource means for compensating for the goods and services provided by the healthcare providers and a means for utilizing a resource means for optimally benefiting healthcare consumers, buyers and providers as a function of optimal healthcare goods and services and proportionate and adjustable compensations based on the utilizations of healthcare goods and services by the healthcare consumers, the dispensations, efficiency and outcomes of services provided by, performances, merits and ranking of the healthcare providers.

### PREFERRED EMBODIMENTS OF THE INVENTION

The present invention is the best healthcare system for solving the current American healthcare crisis and providing readily accessible optimal healthcare to people in America and other countries. In fact, the present invention creates and provides the best healthcare system in the world. It optimizes healthcare providers' productivity, reducing or eliminating healthcare providers' medical errors, curbing the escalating healthcare costs, safeguarding healthcare consumers' health and maximizing healthcare buyers' return by reducing or eliminating wastes and frauds.

In the present invention, consumers such as, patients, and individual, employer, company and government buyers of healthcare products and services and the healthcare providers form a informative, interactive, responsible check-and-balance system of healthcare wherein said people are responsive to the healthcare and financial needs of all involved people. The healthcare providers are such as, but not limited to, physicians, physician assistants, nurses and therapists. The healthcare consumers are such as, but not limited to, patients, individuals and employers. The healthcare buyers are such as, but not limited to patients, individuals, employers, companies, institutions, agencies and departments of the government.

The present invention is the coherent system involving the cohesive and continual management of continuums and links of information on healthcare providers' schedules and availability, medical histories and physical examinations, determinations, actions, plans and prescriptions generated by healthcare providers on patients, financial resources and information generated by the healthcare consumers' and buyers' healthcare-purchasing cooperative or cooperatives comprising pooled resource means for compensating for goods and services provided by said healthcare providers and a means for utilizing said resource means for optimally benefiting said healthcare consumers, buyers and providers as a function of optimal healthcare goods and services and proportionate and adjustable compensations based on the utilizations of said goods and services by said consumers, the dispensations, efficiency and outcomes of services, performances, merits and ranking of said healthcare providers.

Said system comprises the healthcare providers' history and physical examination of any patient leading to their medical assessments of said patient's health, their determinations, actions, plans and prescriptions. Said information are perpetually and continually accessible by other relevant and authorized healthcare providers and individual patient owners of said information.

The system comprises a process of establishing said healthcare providers' schedules and accessibility by said healthcare consumers. A detailed schedule, availability and unavailibility of healthcare providers for any period of time such as, a day, days, weeks or months are accessible to said consumers, other healthcare providers and healthcare buyers. Patients can access and view said schedules and able to see, interact and schedule appointments with any healthcare provider at different locations. The results of the interactions are dictated by the availability and unavailability adaptable to change from moment to moment. The system further allows said parties to instantaneously inform, request and modify the schedules and appointments.

A patient arrives at a healthcare provider's office or hospital and for security, fraud prevention and continuity of the system, said patient's presence is established by a scan of patient's retina pattern, finger prints, or said patient's unique identifications before said patient may proceed further. By so performed, said patient has engaged the process of recording and documenting his or her physical engagement with and presence in the office or clinic of said healthcare provider.

The patient is seen by the healthcare provide and, as a result, a new set of information comprising the healthcare provider's medical history and physical examination, assessments, actions, plans and prescriptions are generated on said patient. Said up-to-date information is available for inspection and modification by authorized people such as healthcare providers and patients. For example, the system allows a patient to access, update and peruse said health information available to said healthcare providers from any setting such as, but not limited to, home and office. Moreover, said information permit the process of automatic double-checking said patient's physical presence in said healthcare provider's office or clinic as a determinant for compensating for goods and service provided by a healthcare provider.

Said healthcare provider's findings, assessments, actions, plans and prescriptions in the system allows and facilitates the continuity of care of the patient by all involved and authorized healthcare providers including those filling the prescriptions ordered by a healthcare provider. For example, said processes result in the healthcare provider's findings, assessments, actions, plans and prescriptions can be accessed and perused by a radiologist or pharmacist filling the prescriptions. Consequently, the information generated by these latter healthcare providers goes through said processes taken by earlier healthcare provider. The data and information can be accessed, retrieved and perused by said healthcare provider who initially wrote the prescriptions. Moreover, it serves as another automatic cross-check of a patient's physical engagement with said healthcare providers and, consequently, it serves as a determinant for compensating for the goods and services provided by said healthcare providers.

In the present invention, American and foreign healthcare buyers of healthcare goods and services contribute their resources such as money and incentives into a pool or pools of money and incentives which are to be used to pay and compensate for the healthcare goods and services being rendered by physicians and healthcare in America and other countries. Said pool or pools of money and incentives are managed and administered by a healthcare-purchasing cooperative or healthcare purchasing cooperatives in America and other countries wherein said resources can be managed, allocated, renewed, invested, used for paying said goods and services. In certain settings, said resources are fully owned and managed by said consumers and individual, employer, company and government buyers until such a time when a portion of said resources are paid out as compensations to said healthcare providers.

The present invention further provides the method and means for optimally utilized said financial resources in return for optimal healthcare goods and services being provided and rendered to said consumers and individual, employer, company and government buyers and owners of said financial resources by said healthcare providers. For example, an allocation of said resources is a function of costs per consumer, number of consumers and healthcare providers, dispensations, utilizations, allocations, administration of goods and services and time.

In this informative, interactive, responsible and check-and-balance healthcare system, all people including the uninsured and people from other countries have access to the optimal and best healthcare at the most affordable and nominal costs. Moreover, the costs to an individual consumer or buyer are based various financial circumstances and settings such as, but not limited to, incomes, ability to pay, standards of living, number of persons in a household or a company. From the perspective of the present invention, all healthcare providers are participants of said system without discrimination and regardless of affiliations.

The system allows the unification and coordination of efforts and utilization of all financial, and human resources of said consumers, individual, employer, company and government buyers and owners, corporation, physicians and healthcare providers. For example, the record, tracking, analysis and correlation of the dispensations, utilizations, allocations and administration of said financial resources and healthcare goods and services by said parties; the performance, efficiency, treatment and preventive medicine means, modes and positive and negative outcomes relating to a physician, a healthcare professional, a group of physicians or healthcare professionals or a network of physicians or healthcare professionals; compare and analyze said information and data among said parties, cohorts and peers, etc.

Based on the above sorting, ranking and data, every healthcare provider is proportionately compensated. In other words, for example, said information and data are used to determine and adjust variable amounts of compensations based on said factors such as, but not limited to, availability of said resource means, dispensations, utilizations, allocations and administration, performance, efficiency, merits, treatment and preventive medicine means, modes and positive and negative outcomes of a healthcare provider or groups of healthcare providers. Of course, labor, material and overhead costs per geographic location are incorporated into said data such as the rents, prices and employee wages in different locations.

A simplified example of utilizations based on said incentive approach is a sample case in diabetes. If a national norm for an established diabetic patient's visit to an endocrinologist's office is three visits per month at a cost of $X per month. Various extenuated factors are entered and considered, the same endocrinologist may be compensated by said cooperative or cooperatives for the same amounts covering only three visits for all total visits greater than three per month for a said given patient. On the contrary, the same endocrinologist will have highest ranking and visibility. However, the disincentive is applied to same if patient(s) of same ends up seeing other endocrinologist(s) or developed diabetic-related complications or emergencies necessitating more healthcare.

Another simple example is the arthroscopic surgery for arthritic knee, useless or ineffective devices, or expensive drugs in lieu of cheaper drugs of same indication and efficacy. The utilizations and dispensations of these goods and services resulted in no or lesser compensations by the cooperatives to all parties involved. If consumers so choose to have useless or ineffective, said consumers will need to pay out of pocket.

However, a universally simplified means for compensating for goods and services provided by a healthcare provider to a patient for a given physical encounter is a function of a disease or disorder. In other words, a disease or disorder is assigned a compensation sum as a function of dispensations, utilizations, allocations and administration, performance, efficiency, merits, treatment and preventive medicine means, modes and positive and negative outcomes. To further simply said equation, a disease or disorder carries a dollar value of compensation as a function of provider's expertise or specialty, expense of time and time, material, labor and capital costs.

Although the preferred embodiments have been described, it will be appreciated by those skilled in business, sciences and medicine that variations, additions and adaptations to the present invention can be had without departing from the spirit of the invention and the scope of the claims.

The terms health-care, health care and healthcare have the same meaning and application herein.

1. The best healthcare system for optimizing healthcare providers' productivity, reducing or eliminating healthcare providers' medical errors, safeguarding healthcare consumers' health, and maximizing healthcare buyers' return comprising continuums of information on the accessibility to healthcare providers, healthcare providers' medical histories and physical examinations, determinations, actions, plans and prescriptions relate to healthcare consumers, healthcare consumers' and buyers' healthcare-purchasing cooperative or cooperatives comprising pooled resource means for compensating for goods and services provided by said healthcare providers and a means for utilizing said resource means for optimally benefiting said healthcare consumers, buyers and providers as a function of optimal healthcare goods and services and proportionate and adjustable compensations based on the utilizations of said goods and services by said consumers, the dispensations, efficiency and outcomes of services, performances, merits and ranking of said healthcare providers.

2. The continuums according to claim 1 wherein said accessibility of healthcare providers' availability, medical history and physical examinations, determinations, actions, plans and prescriptions relate to healthcare consumers comprises:
a process of establishing said healthcare providers' schedules and accessibility by said healthcare consumers;
a process of establishing a healthcare provider's availability and nonavailibility for a healthcare consumer;
a process of engaging consumers' appointments and said schedules;
a process of recording the fulfillment of a physical engagement involving a healthcare consumer and a healthcare provider.
an automatic process of checking said physical engagement of a healthcare consumer with a healthcare provider as a determinant for compensations for goods and services provided by a healthcare provider;
a process of assisting and optimizing a healthcare provider's decision makings, determinations and algorithmic actions; and
a process of accessing a healthcare provider's findings, assessments, actions, plans and prescriptions by a healthcare consumer and healthcare providers.

3. The continuums according to claim 1 wherein said healthcare consumers' and buyers' healthcare-purchasing cooperative or cooperatives comprises:
a pool resource means for compensating said healthcare providers for medical goods and services;
a process of accessing a healthcare provider's findings, assessments, actions, plans and prescriptions as a determinant for compensating for goods and services provided by a healthcare provider;
a process of accessing information on a healthcare provider's findings, assessments, actions, plans and prescriptions by a healthcare consumer;
a process of verifying information on a healthcare provider's findings, assessments, actions, plans and prescriptions by healthcare providers;
a process of verifying information on a healthcare provider's findings, assessments, actions, plans and prescriptions by healthcare buyers; and
an automatic process of cross-checking a physical engagement involving a healthcare consumer and a healthcare provider, a healthcare provider's and healthcare providers' findings, assessments, actions, plans and prescriptions as a determinant for compensations for goods and services provided by a healthcare provider.

4. The continuums according to claim 1 wherein said means for utilizing said resource means for optimally benefiting said consumers, buyers, healthcare providers as a function of optimal healthcare goods and services and proportionate and adjustable compensations based on the utilizations of said goods and services by said consumers, the dispensations, efficiency and outcomes of services, performances, merits and ranking of said healthcare providers comprises:
an automatic process of checking a physical engagement of a healthcare consumer with a healthcare provider as a determinant for compensations for goods and services provided by a healthcare provider;
an automatic process of cross-checking a physical engagement involving a healthcare consumer and a healthcare provider, a healthcare provider's and healthcare providers' findings, assessments, actions, plans and prescriptions as a determinant for compensations for goods and services provided by a healthcare provider.
a process of renewing, managing, allocating, disbursing and investing said resource means to meet needs, requirements and obligations of said consumers, buyers and healthcare providers;
a process of collecting, tracking, recording, sorting and analyzing the dispensations and utilizations of healthcare goods and services;
a process of collecting, recording, sorting and analyzing the outcomes of said healthcare goods and services;
a process of collecting, recording, sorting and analyzing said dispensations, utilizations and outcomes relate to a healthcare provider;
a process of collecting, recording, sorting and analyzing said dispensations, utilizations and outcomes relate to a healthcare provider relative to said dispensations, utilizations and outcomes of cohort healthcare providers;
a process of ranking a healthcare provider relative to peers as a function of said dispensations, utilizations, performance, efficiency, treatment and preventive medicine means, modes and outcomes;
a process of sorting healthcare providers based on said dispensations, utilizations, performance, efficiency, treatment and preventive medicine means, modes and outcomes;
a process of facilitating the access of consumers, buyers and healthcare-purchasing cooperatives to a healthcare provider based on ranking and sorting as a function of said dispensations, utilizations, performance, merits, efficiency, treatment and preventive medicine means, modes and outcomes;
a process of proportionately compensating a healthcare provider based on said consumers' utilizations of said goods and services, physician's or healthcare professional's dispensations of said goods and services and said data relating to dispensations, utilizations, performance, merits, efficiency, treatment and preventive medicine means, modes and outcomes; and
a process of adjustably compensating a healthcare provider based on said consumers' utilizations of said goods and services, healthcare provider's dispensations of said goods and services and said data relating to dispensations, utilizations, performance, merits, efficiency, treatment and preventive medicine means, modes and outcomes.

5. A method of curbing American healthcare costs, optimizing the deliveries and utilizations of healthcare resources and outcomes for Americans including the uninsured and citizens of the world comprising a means for optimizing healthcare providers' productivity, safeguarding healthcare consumers' health, reducing or eliminating healthcare providers' medical errors and maximizing healthcare buyers' yield comprising continuums of information on the accessibility to healthcare providers, healthcare providers' medical histories and physical examinations, determinations, actions, plans and prescriptions relate to healthcare consumers, healthcare consumers' and buyers' healthcare-purchasing cooperative or cooperatives comprising pooled resource means for compensating for goods and services provided by said healthcare providers and a means for utilizing said resource means for optimally benefiting said healthcare consumers, buyers and providers as a function of optimal healthcare goods and services and proportionate and adjustable compensations based on the utilizations of said goods and services by said consumers, the dispensations, efficiency and outcomes of services, performances, merits and ranking of said healthcare providers comprises:
a process of establishing said healthcare providers' schedules and accessibility by said healthcare consumers;
a process of establishing a healthcare provider's availability and nonavailibility for a healthcare consumer;
a process of engaging consumers' appointments and said schedules;
a process of recording the fulfillment of a physical engagement involving a healthcare consumer and a healthcare provider.
an automatic process of checking said physical engagement of a healthcare consumer with a healthcare provider as a determinant for compensations for goods and services provided by a healthcare provider;
a process of assisting and optimizing a healthcare provider's decision makings, determinations and algorithmic actions;
a process of accessing a healthcare provider's findings, assessments, actions, plans and prescriptions by a healthcare consumer and healthcare providers.
a pool resource means for compensating said healthcare providers for medical goods and services;
a process of accessing a healthcare provider's findings, assessments, actions, plans and prescriptions as a determinant for compensating for goods and services provided by a healthcare provider;
a process of accessing information on a healthcare provider's findings, assessments, actions, plans and prescriptions by a healthcare consumer;
a process of verifying information on a healthcare provider's findings, assessments, actions, plans and prescriptions by healthcare providers;
a process of verifying information on a healthcare provider's findings, assessments, actions, plans and prescriptions by healthcare buyers;
an automatic process of cross-checking a physical engagement involving a healthcare consumer and a healthcare provider, a healthcare provider's and healthcare providers' findings, assessments, actions, plans and prescriptions as a determinant for compensations for goods and services provided by a healthcare provider.
a process of renewing, managing, allocating, disbursing and investing said resource means to meet needs, requirements and obligations of said consumers, buyers and healthcare providers;
a process of collecting, tracking, recording, sorting and analyzing the dispensations and utilizations of healthcare goods and services;
a process of collecting, recording, sorting and analyzing the outcomes of said healthcare goods and services;
a process of collecting, recording, sorting and analyzing said dispensations, utilizations and outcomes relate to a healthcare provider;
a process of collecting, recording, sorting and analyzing said dispensations, utilizations and outcomes relate to a healthcare provider relative to said dispensations, utilizations and outcomes of cohort healthcare providers;
a process of ranking a healthcare provider relative to peers as a function of said dispensations, utilizations, performance, efficiency, treatment and preventive medicine means, modes and outcomes;
a process of sorting healthcare providers based on said dispensations, utilizations, performance, efficiency, treatment and preventive medicine means, modes and outcomes;
a process of facilitating the access of consumers, buyers and healthcare-purchasing cooperatives to a healthcare provider based on ranking and sorting as a function of said dispensations, utilizations, performance, merits, efficiency, treatment and preventive medicine means, modes and outcomes;
a process of proportionately compensating a healthcare provider based on said consumers' utilizations of said goods and services, physician's or healthcare professional's dispensations of said goods and services and said data relating to dispensations, utilizations, performance, merits, efficiency, treatment and preventive medicine means, modes and outcomes; and
a process of adjustably compensating a healthcare provider based on said consumers' utilizations of said goods and services, healthcare provider's dispensations of said goods and services and said data relating to dispensations, utilizations, performance, merits, efficiency, treatment and preventive medicine means, modes and outcomes.

6. The best healthcare system for optimizing healthcare providers' productivity, reducing or eliminating healthcare providers' medical errors, safeguarding healthcare consumers' health, and maximizing healthcare buyers' yield comprising links of information on the accessibility to healthcare providers, healthcare providers' medical histories and physical examinations, determinations, actions, plans and prescriptions relate to healthcare consumers, healthcare consumers' and buyers' healthcare-purchasing cooperative or cooperatives comprising pooled resource means for compensating for the goods and services provided by said healthcare providers and a means for utilizing said resource means for optimally benefiting said consumers, buyers, healthcare providers as a function of optimal healthcare goods and services and proportionate and adjustable compensations based on the utilizations of said goods and services by said consumers, the dispensations, efficiency and outcomes of services, performances, merits and ranking of said healthcare providers.
